(19) United States
(12) Patent Application Publication
(10) Pub. No.: US 2002/0051043 A1
(43) Pub. Date: May 2, 2002

(54) Ink cartridge for preventing ink from spilling

(76) Inventors: Cheng-Wei Hsu, Tainan Hsien (TW); I-Chung Hou, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,219

(22) Filed: Aug. 8, 2001

(30) Foreign Application Priority Data
Nov. 2, 2000 (TW) 089123059

(51) Int. Cl. B41J 2/175

(52) U.S. Cl. 347/86

(57) ABSTRACT

An ink cartridge for an ink printer includes a housing with at least one vertical and isolated ink chamber for storing ink and at least one pore disposed on a top side of the housing for interchanging air with the outside environment, one outputting opening set on a bottom side of the housing and corresponding for outputting ink, a storage material filled in the ink chamber for absorbing the ink within the ink chamber, and a filling covered on the top side of the ink chamber for preventing the ink absorbed by the storage material from spilling out of the ink chamber due to shaking of the ink cartridge.

### BACKGROUND OF INVENTION

1. Field of the Invention

The present invention relates to an ink cartridge for an ink printer, and more particularly, to an ink cartridge with a filling that functions to prevent the ink within the ink cartridge from spilling.

2. Description of the Prior Art

Generally speaking, every ink printer has an ink cartridge for supplying ink. There is at least one ink chamber for storing ink within the ink cartridge and outputting the ink to the ink printer through an opening. For a color ink printer, a plurality of ink chambers are installed for storing different kinds of inks having a variety of colors.

Each ink chamber has its own opening for outputting the ink to the color ink printer.

In an ink chamber for storing the ink in fluid form, a complex pressure balancing system is required for balancing the fluid pressure since ink within the ink chamber is consumed continually. Another technology used for storing the ink includes filling a storage material in the ink chamber and balancing the pressure by connecting the ink chamber with the outside atmosphere. U.S. Pat. No. 4,771,295 uses a porosity filling, which is set for absorbing and storing the ink in the ink chamber. However this kind of porosity filling must be compressed by a particular tool for installation in the ink chamber, and as a result, it is unable to release the ink completely after compression, leading to residual ink remaining in the ink chamber.

Another prior art method involves using a fiber binding covered by a thin film as a storage material. The fiber binding is a storage material with a direction, meaning that ink absorbed by the fiber binding flows along one specific direction of the fiber binding and then flows along another direction, thereby saturating the storage material with the ink. When the ink cartridge is shaken by some degree, the ink within the ink cartridge is spilled out of the ink cartridge via the opening of the ink chamber, not only spotting the document of the ink printer but also mixing up the inks from other ink chambers.

### SUMMARY OF INVENTION

It is an object of the present invention to provide an ink cartridge for preventing the ink within it from spilling out.

In accordance with the claimed invention, an ink cartridge for a ink printer includes a housing with at least one vertical and isolated ink chamber for storing ink and at least one pore disposed on a top side of the housing for interchanging air with the outside environment. One outputting opening is set on a bottom side of the housing for outputting ink, a storage material filled in each of the ink chambers for absorbing the ink within the ink chamber, and a filling covering the top side of the ink chamber for preventing the ink absorbed by the storage material from spilling out of the ink chamber due to shaking of the ink cartridge.

It is an advantage of the present invention that fillings with different characteristics and arrangements are able to prevent ink spillage.

These and other objectives of the present invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a perspective view of an ink cartridge of the present invention.

FIG. 2 is a structure schematic diagram of a first embodiment of the present invention.

FIG. 3 is a structure schematic diagram of a second embodiment of the present invention.

FIG. 4 is a structure schematic diagram of a third embodiment of the present invention.

FIG. 5 is a structure schematic diagram of a fourth embodiment of the present invention.

FIG. 6 is a structure schematic diagram of a fifth embodiment of the present invention.

### DETAILED DESCRIPTION

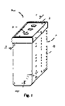

Please refer to FIG. 1 of a perspective view of an ink cartridge 10 of the present invention. The ink cartridge 10 comprises a housing 14 covered by a cap 12. At least one ink chamber 18 for storing the ink is set within the housing 14 and has a corresponding outputting opening 80 for outputting the ink while operating. There is at least one pore 16 on a top end of the cap 12 corresponding to each ink chamber 18 for interchanging the air inside it with the outside atmosphere.

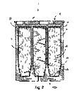

Please refer to FIG. 2 of a structure schematic diagram for the ink cartridge 10 shown in FIG. 1. The ink cartridge 10 has three ink chambers 18 for storing inks with a variety of colors. Each ink chamber 18 has its corresponding output opening 80 and its corresponding pore disposed on the top end of the cap 12.

A storage material 50 is filled into each ink chamber 18 for absorbing the ink within the ink chamber 18. The storage material 50 is a directional fiber binding 54 which is covered by a bending thin-film form 52 for engaging with the ink chamber 18. The directional fiber binding 54 is parallel in a vertical direction along the ink chamber 18 so that the ink is able to flow to the outputting opening 80 smoothly.

There is a filtering layer 56, for filtering bubbles of the ink and maintaining the quality of the ink, between the outputting opening 80 and the storage material 50.

As described above, the ink is able to flow along the direction of the directional fiber binding 54. If the ink cartridge 10 is shaken to some degree, the ink flowing along the directional fiber binding 54 might be spilled out of the ink chamber 18 through the pore 16 and more seriously, might flow into other ink chambers 18 for mixing up the ink and undermining the printing quality. The ink cartridge 10 further comprises a filling 100 within the ink chamber 18 located between the pore 16 and the storage material 50 for preventing the ink from spilling out of the ink chamber 18 through the pore 16.

The filling 100 consists of a thin strip incapable of absorbing water. If the ink is spilled out of the ink chamber 18 through the top end of the storage material 50, the thin strip blocks the ink from spilling out of the ink cartridge 10 via the pore 16 continually. Since the thin strip is not engaged with the periphery closely, the ink chamber 18 can interchange the air inside the ink chamber with the outside atmosphere via the pore 16.

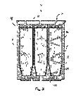

Please refer to FIG. 3 of a structure schematic diagram of a second embodiment of the present invention. A porosity filling 200 is located between the pore 16 and the storage material 50. The capillary action of the porosity filling 200 is less than that of the storage material 50 so that the porosity filling 200 does not absorb the ink stored in the storage material 50. Once the ink is spilled out due to shaking of the ink cartridge 10, the porosity filling 200 absorbs the spilled ink and thus prevents the ink from being spilled out of the ink cartridge via the pore 16. Since the porosity filling 200 allows air to flow in and out, the ink chamber 18 can interchange the air with the outside atmosphere through the pore 16 and the porosity filling 200.

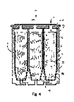

Please refer to FIG. 4 of a structure schematic diagram for a third embodiment of the present invention. While refilling the ink, the ink is injected into the ink chamber 18 by an injecting pin through the pore 16 of the cap 12 so that the size of the pore 16 must accommodate the injecting pin. In this kind of situation, the configuration of installing a filling between the pore 16 and the storage material 50 is inappropriate. In this embodiment, a thin film 300 is adheres to the top end of the cap 12 and has openings 310 disposed located where the pores 16 are installed for allowing the ink chamber 18 to interchange air with the outside atmosphere. The size of the opening 310 is smaller than that of the pore 16, so the ink is unable to be spilled out of the ink chamber 18 through the opening 310.

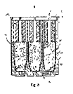

Please refer to FIG. 5 of a structure schematic diagram for a fourth embodiment of the present invention. Pillars 400 separate the space between the storage material 50 and the cap 12 so increasing the distance between the pore 16 and the storage material 50 and preventing the spilled ink from the ink chamber 18 from flowing out of the ink cartridge 10 through the pore 16.

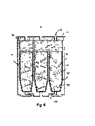

Please refer to FIG. 6 of a structure schematic diagram of a fifth embodiment of the present invention. The filling 500 consists of a directional fiber binding and as those the storage material 50. However a major difference between the directional fiber binding of the filling 500 and that of the storage material 50 is their directions. The directional fiber binding of the filling has with a horizontal direction. When the ink is spilled out of the ink chamber 18, it flows horizontally and does not spill out of the ink cartridge 10 through the pore 16.

The present invention provides a filling that effectively blocks the pore of the ink cartridge to prevent ink from spilling out of the ink cartridge while not interfering in the interchanging of the air between the ink chamber and the outside atmosphere.

The ink cartridge can adopt the fiber binding covered by a thin-film form as a storage material, while engaging with the ink chamber properly, and so no particular tool is needed for compressing the fiber binding into the ink chamber. The ink cartridge of the present invention further includes a filling with different characteristics and arrangements for preventing the ink from being spilled out of the ink cartridge.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An ink cartridge for an ink printer comprising:
a housing with at least one vertical and isolated ink chamber for storing ink and at least one pore disposed on a top side of the housing for interchanging air with an outside environment;
at least one outputting opening, that is set on a bottom side of the housing and corresponds to the ink chamber, for outputting ink while the ink printer is operating;
a storage material, filled in each of the ink chamber, for absorbing the ink within the ink chamber; and
a filling, covered on the top side of the ink chamber, for preventing the ink absorbed by the storage material from spilling out of the ink chamber due to shaking of the ink cartridge.

2. The ink cartridge of claim 1 wherein the filling is a porosity filling comprising a plurality of multilateral pores for absorbing the ink spilled out of the storage material and preventing the ink from spilling out of the ink chamber via the pores.

3. The ink cartridge of claim 2 wherein the porosity filling consists of sponges.

4. The ink cartridge of claim 3 wherein the sponges are covered on the top side of each of the ink chamber by a thin-film form.

5. The ink cartridge of claim 1 wherein the housing comprises a cap, a bottom end of the cap engaged with the ink chamber, located over the ink chamber and the pore is located on a top end of the cap, the bottom end of the cap comprises holes for routing the ink chamber and the pore on the top end of the cap, and the filling is fixed between the bottom end of the cap and the storage material.

6. The ink cartridge of claim 5 wherein the filling is covered on the top side of the storage material within the ink chamber by a thin-film form.

7. The ink cartridge of claim 1 wherein a capillary action of the filling is less than the capillary action of the storage material.

8. The ink cartridge of claim 1 wherein the filling is a solid material with the pores for increasing the distance between the storage material of each of the ink chamber and the top side of the housing to enhance the effect of isolating the ink.

9. The ink cartridge of claim 1 wherein the storage material is a directional fiber binding, which is parallel in a vertical direction.

10. The ink cartridge of claim 9 wherein the quality of the filling and the quality of the storage material are the same and the direction of the storage material is vertical to the direction of the storage material.
